(19) United States
(12) Patent Application Publication
(10) Pub. No.: US 2024/0021912 A1
(43) Pub. Date: Jan. 18, 2024

(54) BATTERY PACK

(71) Applicant: BYD COMPANY LIMITED, Shenzhen (CN)

(72) Inventors: Bojun XIONG, Shenzhen (CN); Qingbo PENG, Shenzhen (CN); Ning YI, Shenzhen (CN)

(21) Appl. No.: 18/373,794

(22) Filed: Sep. 27, 2023

Related U.S. Application Data
(63) Continuation of application No. PCT/CN2022/100482, filed on Jun. 22, 2022.

(30) Foreign Application Priority Data
Jun. 30, 2021 (CN) 202110739653.1

(51) Int. Cl. H01M 10/6556; H01M 10/613; H01M 10/625; H01M 10/6554; H01M 10/6568; H01M 50/271; H01M 50/242; H01M 10/615; H01M 10/657; H01M 50/249

(52) U.S. Cl. CPC H01M 10/6556; H01M 10/613; H01M 10/625; H01M 10/6554; H01M 10/6568; H01M 50/271; H01M 50/242; H01M 10/615; H01M 10/657; H01M 50/249; H01M 2220/20; B60R 16/033

(57) ABSTRACT

A battery pack includes: a battery box having a distribution cavity; a distribution box disposed in the distribution cavity; the distribution box including a panel; the panel having a first flow channel and a refrigerant inlet/outlet joint in communication with the first flow channel; and a thermoregulation member connected with the battery box; the thermoregulation member having a second flow channel in communication with the first flow channel.

### CROSS-REFERENCE TO RELATED APPLICATIONS

This application is a Continuation application of International Patent Application No. PCT/CN2022/100482, filed on Jun. 22, 2022, which is based on and claims priority to and benefits of Chinese Patent Application No. 202110739653.1, filed on Jun. 30, 2021. The entire content of all of the above-referenced applications is incorporated herein by reference.

### FIELD

The present disclosure relates to the technical field of battery packs, and more particularly, to a battery pack.

### BACKGROUND

In the related art, a cooling structure is arranged/disposed in a battery box. However, the cooling structure may cool only a cell inside the battery box. As a result, a distribution box cannot be effectively cooled, or another cooling structure needs to be arranged/configured, which leads to high overall design costs and reduces working performance of the battery pack.

### SUMMARY

The present disclosure resolves at least one of the technical problems existing in the related art. The present disclosure provides a battery pack.

The battery pack in embodiments of the present disclosure includes a battery box and a thermoregulation member. The battery box has a distribution cavity. A distribution box is disposed in the distribution cavity. The distribution box includes a panel. The panel has a first flow channel and a refrigerant inlet/outlet joint in communication with the first flow channel. The thermoregulation member is connected with the battery box. The thermoregulation member has a second flow channel connected with the first flow channel.

In the battery pack in some embodiments of the present disclosure, the thermoregulation member is disposed below the battery box. A liquid cooling avoidance port is disposed on a bottom wall of the distribution cavity. An adapter of the second flow channel extends through the liquid cooling avoidance port and is in communication with the first flow channel.

In the battery pack in some embodiments of the present disclosure, the adapter includes an adapter inlet and an adapter outlet. The adapter inlet and the adapter outlet extend into the distribution cavity through the liquid cooling avoidance port.

In the battery pack in some embodiments of the present disclosure, the refrigerant inlet/outlet joint includes an outer inlet and an outer outlet disposed on an outer side surface of the panel. The outer inlet is in communication with the adapter inlet. The outer outlet is in communication with the adapter outlet. The outer inlet and the outer outlet are configured to be in communication with an external pipeline.

In the battery pack in some embodiments of the present disclosure, a mounting port in communication with an outside of the battery box is disposed in the distribution cavity; the panel is disposed facing the mounting port; and the outer inlet and the outer outlet extend through the mounting port.

In the battery pack in some embodiments of the present disclosure, the battery box includes a box portion and a sealing cover. The thermoregulation member is connected with the box portion. The sealing cover is mounted to an end portion of the box portion. The sealing cover and the box portion define the distribution cavity. The sealing cover includes the mounting port.

The battery pack in some embodiments of the present disclosure further includes a bottom protection plate. The bottom protection plate covers a bottom of the battery box. The thermoregulation member is located between the battery box and the bottom protection plate.

The battery pack in some embodiments of the present disclosure further includes a heating film. The heating film is mounted above or below the battery box. The heating film is electrically connected with the distribution box.

In the battery pack in some embodiments of the present disclosure, the heating film is disposed between the battery box and the thermoregulation member. A lead avoidance port is disposed on the bottom wall of the distribution cavity. The lead avoidance port is spaced apart from the liquid cooling avoidance port. An electrode lead of the heating film extends through the lead avoidance port and is electrically connected with the distribution box.

In the battery pack in some embodiments of the present disclosure, the heating film is disposed above the battery box. A top wall of the battery box includes the lead avoidance port. The electrode lead of the heating film extends through the lead avoidance port and is electrically connected with the distribution box.

The battery pack in some embodiments of the present disclosure further includes a sealing plate. The sealing plate is mounted above the battery box. The heating film is located between the sealing plate and the battery box.

In the battery pack in some embodiments of the present disclosure, the bottom protection plate includes a groove area recessed downward and a connection turnup surrounding the groove area. The connection turnup is configured to be detachably connected with the battery box. The thermoregulation member is mounted in the groove area.

In the battery pack in some embodiments of the present disclosure, the battery box further includes a cell mounting cavity. The cell mounting cavity is configured to mount a cell. The distribution cavity is located at an end portion of the cell mounting cavity. The cell is electrically connected with the distribution box.

Additional aspects and advantages of the present disclosure are partially provided in the following description, some of which will become apparent from the following description or may be learned from practices of the present disclosure.

### BRIEF DESCRIPTION OF THE DRAWINGS

The above and/or additional aspects and advantages of the present disclosure will become apparent and comprehensible from description of embodiments provided with reference to the following drawings.

FIG. 1 is an exploded view of a battery pack according to an embodiment of the present disclosure.

FIG. 2 is an enlarged view of A in FIG. 1.

FIG. 3 is a schematic structural diagram (a heating film is connected with a distribution box) of a heating circuit of a heating film of the battery pack according to an embodiment of the present disclosure.

FIG. 4 is an exploded view of the battery pack according to some other embodiments of the present disclosure.

FIG. 5 is an enlarged view of B in FIG. 4.

FIG. 6 is a schematic diagram of a vehicle according to the present disclosure;

FIG. 7 is a sectional view of a panel fitted with a thermoregulation member according to the present disclosure.

FIG. 8 is a schematic diagram of the thermoregulation member according to the present disclosure.

### DETAILED DESCRIPTION

Embodiments of the present disclosure are described in detail below, and examples of the embodiments are shown in the drawings, where the same or similar elements or the elements having the same or similar functions are represented by the same or similar reference numerals throughout the description. The embodiments described below with reference to the drawings are exemplary and used only for explaining the present disclosure, and should not be construed as a limitation on the present disclosure.

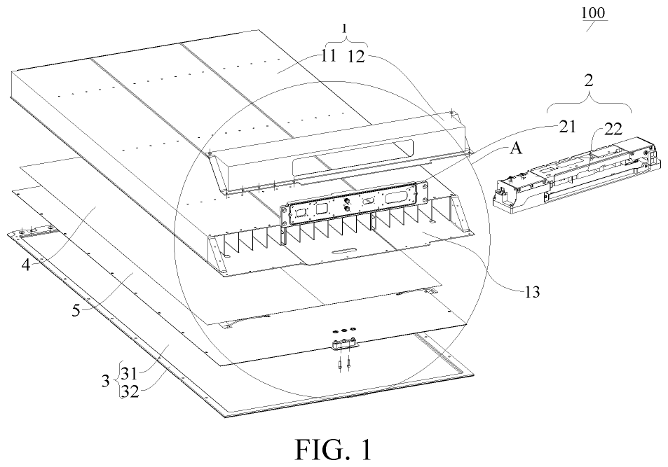

A battery pack 100 in the embodiments of the present disclosure is described below with reference to FIG. 1 to FIG. 8.

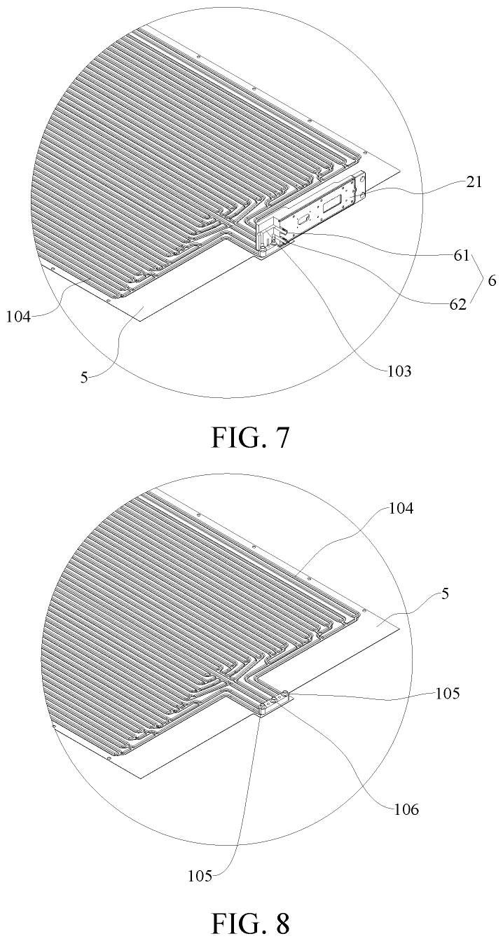

As shown in FIG. 1, FIG. 4, and FIG. 7, the battery pack 100 in the embodiments of the present disclosure includes a battery box 1 and a thermoregulation member 5.

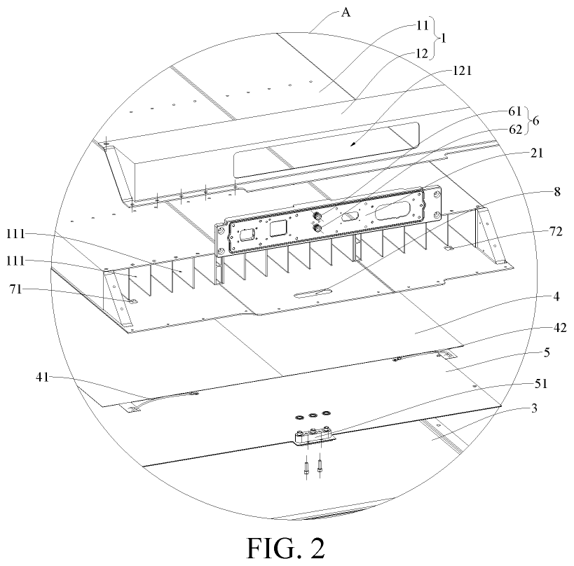

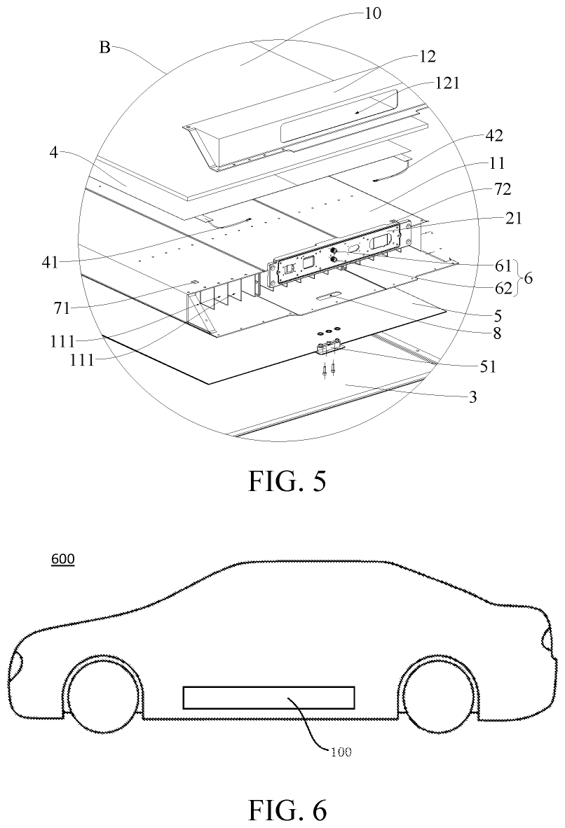

The battery box 1 may be made of an aluminum alloy material, so as to reduce an entire weight of the battery pack 100 and achieve a lightweight design of the battery pack 100. The battery box 1 may be configured as a hollow cavity structure, in which a mounting space is formed to facilitate mounting of a cell inside the battery box 1, so that the battery box 1 can support and protect the cell, thereby ensuring the stability of the cell. In addition, the battery box 1 has a distribution cavity 13. The distribution cavity 13 is formed on an upper side of the battery box 1, and a distribution box 2 is arranged/disposed in the distribution cavity 13, which facilitates mounting of the distribution box 2 in the distribution cavity 13, thereby reducing difficulty in mounting the distribution box 2 for a quick mounting, and facilitates power distribution for the cell inside the battery box 1. The distribution box 2 may include a distribution assembly or a distribution module 21 and a panel 22. The panel 22 is fixedly connected with the distribution module 21, and the panel 22 is provided with a refrigerant inlet/outlet joint 6 exposed to the battery box 1. The panel 22 is provided with a first flow channel 103 and the refrigerant inlet/outlet joint 6 in communication with the first flow channel 103. As shown in FIG. 2 and FIG. 5, the refrigerant inlet/outlet joint 6 is arranged/disposed on the panel 22 and is extended away from the battery box 1, to facilitate the communication of the refrigerant inlet/outlet joint 6 with an external pipeline, thereby reducing the difficulty in connecting to the external pipeline, improving the assembly efficiency, facilitating disassembly of the external pipeline, and reducing maintenance costs.

The thermoregulation member 5 is connected with the battery box 1, and the thermoregulation member 5 has a second flow channel 104 in communication with the first flow channel 103. That is to say, the first flow channel 103 and the second flow channel 104 may be in communication with the external pipeline through the refrigerant inlet/outlet joint 6. It may be understood that the thermoregulation member 5 may be connected to the battery box 1 through a thermally conductive structural adhesive, to fixedly mount the thermoregulation member 5 to the battery box 1, thereby ensuring the stability of the connection between the thermoregulation member and the battery box. In addition, the first flow channel 103 and the second flow channel 104 may be in communication with the external pipeline through the refrigerant inlet/outlet joint 6, so that a refrigerant may flow in the first flow channel 103 to cool the distribution box 2. Moreover, the refrigerant may flow to the second flow channel 104 through the first flow channel 103 to cool the cell, which facilitates temperature control of the cell in the battery box 1. In this way, surroundings of the cell have a uniform temperature during heating or cooling, which reduces life degradation of the cell caused by non-uniform temperatures.

In the battery pack 100 in the embodiments of the present disclosure, through configuration of the whole flow channel that communicates the thermoregulation member 5 with the panel 22, not only the cell can be cooled, but also electrical elements in the distribution box 2 can be cooled, so that the thermoregulation member 5 and the panel 22 do not need to be provided with additional pipe joints. Therefore, a quantity of pipe joints is reduced, fewer cooling structures are required, and cooling costs are lower, and life degradation of the cell caused by non-uniform temperatures can be reduced.

In some embodiments, the thermoregulation member 5 is arranged/disposed below the battery box 1. The thermoregulation member is connected to the battery box through the thermally conductive structural adhesive, to fixedly mount the thermoregulation member 5 below the battery box 1, thereby ensuring the stability of the connection between the thermoregulation member and the battery box. As shown in FIG. 2, a lead avoidance port and a liquid cooling avoidance port 8 are arranged/disposed on a bottom wall of the distribution cavity 13 spaced apart from each other, to reduce the difficulty in forming the lead avoidance port and the liquid cooling avoidance port, and to shield the lead avoidance port and the liquid cooling avoidance port 8 through the distribution box 2. In this way, water can be prevented from entering the lead avoidance port and the liquid cooling avoidance port 8, and the lead avoidance port and the liquid cooling avoidance port 8 become invisible when viewed from outside of the battery pack 100, thereby enhancing safety of the battery pack.

An adapter of the second flow channel 104 extends through the liquid cooling avoidance port 8 and is in communication with the first flow channel 103. That is to say, the liquid cooling avoidance port 8 is configured to avoid to an adapter 51 of the thermoregulation member 5, and the adapter is in communication with the first flow channel 103 and the second flow channel 104 simultaneously. In other words, the thermoregulation member 5 is directly connected to the refrigerant inlet/outlet joint 6 through the liquid cooling avoidance port 8, which reduces a length of connection between the thermoregulation member and the refrigerant inlet/outlet joint, reduces an entire volume of the battery pack 100, and facilitates formation of a refrigerant circuit between the thermoregulation member 5 and the refrigerant inlet/outlet joint 6. That is to say, the refrigerant may move to the thermoregulation member 5 through the distribution box 2, so that the cell may be heated or cooled through the thermoregulation member 5, thereby ensuring that the cell is in a uniform temperature condition, improving a service life of the cell, avoiding thermal runaway of the cell caused by a high temperature, and enhancing safety of the battery pack 100.

As shown in FIG. 2 and FIG. 8, the liquid cooling avoidance port 8 may be configured as an oblong port. In this way, processing difficulty is reduced, and an adapter inlet 105 and an adapter outlet 106 of the thermoregulation member 5 both may extend to the distribution cavity 13 through the liquid cooling avoidance port 8. It should be noted that, the adapter 51 includes the adapter inlet 105 and the adapter outlet 106. The adapter inlet 105 and the adapter outlet 106 of the adapter 51 both extend into the distribution cavity 13 through the liquid cooling avoidance port 8, and are connected with a bottom wall of the panel 22, and are fixed at a joint between the thermoregulation member 5 and the distribution box 2 through a fixing structure. The fixing structure may be a bolt. In this way, the stability of the connection between the thermoregulation member 5 and the distribution box 2 is enhanced.

The first flow channel 103 includes a bottom inlet and a bottom outlet arranged/disposed on the bottom wall of the panel 22. The bottom inlet is connected with the adapter inlet 105, and the bottom outlet is connected with the adapter outlet 106. In this way, the refrigerant may enter an outer inlet 61 through the external pipeline, and then successively pass through the bottom inlet, the adapter inlet 105, the adapter outlet 106, the bottom outlet, and an outer outlet 62. Therefore, the distribution box 2 and the cell can be effectively cooled, so that a high temperature of the distribution box 2 and the cell can be avoided, and it is ensured that the cell is in a working environment with a normal temperature, thereby enhancing the safety of the battery pack 100.

In some embodiments, as shown in FIG. 2, a mounting port 121 in communication with outside is arranged/disposed in the distribution cavity 13, and the panel 22 is arranged/disposed directly facing the mounting port 121. It may be understood that the mounting port 121 can be configured as an elongated hole. The mounting port 121 is configured to avoid the panel 22, which facilitates the user operations on the panel 22, thereby improving convenience of the user operations.

As shown in FIG. 2, the refrigerant inlet/outlet joint 6 includes the outer inlet 61 and the outer outlet 62 arranged/disposed on the panel 22. The outer inlet 61 and the outer outlet 62 are both located on the panel 22, and the outer inlet 61 and the outer outlet 62 extend through the mounting port 121 to outside of the mounting port 121, so that the outer inlet 61 and the outer outlet 62 can be in communication with the external pipeline, which reduces the difficulty in connecting to the external pipeline, improves the assembly efficiency, facilitates disassembly of the external pipeline, reduces maintenance costs, and facilitates user operations on the distribution box 2 through the panel 22 at the mounting port 121, thereby enhancing safety and practicality of the distribution box 2.

As shown in FIG. 1 and FIG. 2, in some embodiments, the battery box 1 includes a box portion 11 and a sealing cover 12.

A heating film 4 is connected with the box portion 11, which is configured to be turned on at a low temperature to heat the battery pack 100, so as to achieve thermal uniformity of the battery pack 100, thereby improving the service life of the cell. In addition, the heating film 4 is mounted to an outer side of the battery box 1 and is connected through a thermally conductive structural adhesive, so that surroundings of the cell can have a uniform temperature during heating or cooling through high thermal conductivity of the aluminum alloy battery box, thereby reducing life degradation of lithium batteries caused by non-uniform temperatures.

The sealing cover 12 may be configured as a structure with an opening. The sealing cover 12 is mounted to an end portion of the box portion 11 and defines the distribution cavity 13 with the box portion 11, so as to fixedly mount the distribution box 2 in the distribution cavity 13, thereby preventing displacement or detachment of the distribution box 2, and enhancing stability of the distribution box 2. Moreover, the opening of the sealing cover 12 is recessed away from an upper surface of the box portion 11, so as to mount the sealing cover 12 on an upper side of the box portion 11. Further, the sealing cover 12 and the box portion 11 jointly define the distribution cavity 13 for mounting the distribution box 2. The sealing cover 12 is provided with the mounting port 121. The mounting port 121 is arranged/disposed on a side wall of the sealing cover 12. The mounting port 121 may be configured as an elongated hole. The mounting port 121 is configured to avoid to the panel 22, to facilitate the user operations, thereby improving the convenience of the user operations. It may be understood that during mounting, the distribution box 2 may be first mounted to an upper surface of the box portion 11, then the sealing cover 12 is mounted to the distribution box 2, and the panel 22 protrudes out through the mounting port 121. In this way, the sealing cover 12 can protect the distribution box 2, which prevents the distribution box 2 from the direct impact, and facilitates the user operations on the distribution box 2 through the panel 22 at the mounting port 121, thereby enhancing the safety and practicality of the distribution box 2.

It should be noted that, the sealing cover 12 and the upper surface of the box portion 11 are sealed by using a bolt and a compressible material through mechanical compression. The level of the sealing may be IP67, which can enhance the sealing and safety of the battery pack 100.

In some embodiments, the battery pack 100 further includes a bottom protection plate 3. The bottom protection plate 3 may be configured as a plate-shaped structure, so as to facilitate mounting of the bottom protection plate 3 below the battery box 1, thereby protecting the battery box 1 through the bottom protection plate 3. In this way, a bottom of the battery box 1 can be prevented from the direct impact, thereby enhancing the safety of the battery pack 100.

The bottom protection plate 3 is mounted to the bottom of the battery box 1, and the thermoregulation member 5 is located between the battery box 1 and the bottom protection plate 3, so that the bottom protection plate 3 can support and protect the thermoregulation member 5, thereby preventing detachment or displacement of the thermoregulation member 5, and enhancing stability of the thermoregulation member 5. In addition, the thermoregulation member 5 is arranged/disposed between a bottom wall of the battery box 1 and the bottom protection plate 3, so that the surroundings of the cell can have a uniform temperature during heating or cooling through control of the thermoregulation member 5, thereby reducing the life degradation of lithium batteries caused by non-uniform temperatures.

It should be noted that, the bottom protection plate 3 and a lower surface of the battery box 1 are sealed by using a bolt and a compressible material. In this way, the thermoregulation member 5 can be reliably sealed between the battery box 1 and the bottom protection plate 3, and thus can be in a stable working environment, thereby improving the sealing and safety of the battery pack 100.

In some embodiments, the battery pack 100 further includes a heating film 4. The heating film 4 is mounted above or below the battery box 1, and the heating film 4 is electrically connected with the distribution box 2. For example, the heating film 4 is mounted above the battery box 1, or the heating film 4 is mounted below the battery box 1. In other words, a mounting position of the heating film 4 may be designed according to different mounting requirements. The heating film 4 is arranged/disposed on the outer side of the battery box 1, which is configured to be turned on at a low temperature to heat the battery pack 100, so as to achieve thermal uniformity of the battery pack 100, thereby improving the service life of the cell. In addition, the heating film 4 is mounted to the outer side of the battery box 1 and is connected through a thermally conductive structural adhesive, so that the surroundings of the cell can have a uniform temperature during heating or cooling through the high thermal conductivity of the aluminum alloy battery box, thereby reducing life degradation of lithium batteries caused by non-uniform temperatures.

As shown in FIG. 1 and FIG. 2, the heating film 4 is arranged/disposed between the battery box 1 and the thermoregulation member 5. The bottom wall of the distribution cavity 13 is provided with the lead avoidance port. The lead avoidance port and the liquid cooling avoidance port 8 are spaced apart from each other, to reduce the difficulty in forming the lead avoidance port and the liquid cooling avoidance port, and to shield the lead avoidance port and the liquid cooling avoidance port 8 through the distribution box 2. In this way, water can be prevented from entering the lead avoidance port and the liquid cooling avoidance port 8, and the lead avoidance port and the liquid cooling avoidance port 8 become invisible when viewed from the outside of the battery pack 100, thereby enhancing the safety of the battery pack.

An electrode lead of the heating film 4 extends through the lead avoidance port and is electrically connected with the distribution box 2. It may be understood that, the heating film 4 is mounted below the battery box 1, the thermoregulation member 5 is also mounted below the battery box 1, the heating film 4 is electrically connected with the distribution box 2, and the bottom wall of the distribution cavity 13 is provided with the lead avoidance port. It may be understood that, in some embodiments, as shown in FIG. 1, the heating film 4 and the thermoregulation member 5 are mounted below the battery box 1. That is to say, the heating film 4 and the thermoregulation member 5 are snugly attached to a low part of the battery box 1 in sequence and are connected through the thermally conductive structural adhesive. In this way, the high heat conductivity can be achieved through the aluminum alloy battery box 1.

The lead avoidance port includes a positive avoidance port 71 and a negative avoidance port 72. The positive avoidance port 71 and the negative avoidance port 72 both may be configured as square holes, so as to reduce the difficulty in forming the positive avoidance port and the negative avoidance port, and to facilitate mounting and connection of another structure. As shown in FIG. 2, the positive avoidance port 71 and the negative avoidance port 72 are respectively located in two end areas of the bottom wall of the battery box 1. In other words, the positive avoidance port 71 and the negative avoidance port 72 are spaced apart on the bottom wall of the battery box 1.

In an embodiment, the electrode lead of the heating film 4 includes a positive lead 41 and a negative lead 42. The positive lead 41 of the heating film 4 extends through the positive avoidance port 71 and is electrically connected with the distribution box 2. The negative lead 42 of the heating film 4 extends through the negative avoidance port 72 and is electrically connected with the distribution box 2. That is to say, the electrode lead of the heating film 4 directly passes through the lead avoidance port and is electrically connected with the distribution box 2, which reduces a length of connection between the electrode lead and the distribution box, reduces an entire volume of the battery pack 100, and facilitates formation of a heating circuit between the heating film 4 and the distribution box 2, that is, the distribution box 2 can supply power to the heating film 4. In this way, during heating of the cell, power is supplied to the heating film 4 through the distribution box 2, so that the heating film 4 is heated up, and then the heat is transmitted to the cell through the battery box 1, to heat up the cell. Through such a configuration, electricity can be obtained inside the heating film 4, which eliminates a need to configure an additional power supply for the heating film 4, thereby reducing costs.

As shown in FIG. 4 and FIG. 5, the heating film 4 is mounted above the battery box 1, a top wall of the battery box 1 is provided with the lead avoidance port, and the electrode lead of the heating film 4 extends through the lead avoidance port and is electrically connected with the distribution box 2. That is to say, the heating film 4 is tightly attached to an upper part of the battery box 1 and is connected through the thermally conductive structural adhesive, thereby achieving the high thermal conductivity through the aluminum alloy battery box 1.

In some embodiments, the lead avoidance port includes a positive avoidance port 71 and a negative avoidance port 72. As shown in FIG. 5, the positive avoidance port 71 and the negative avoidance port 72 are respectively located in two side areas of the top wall of the battery box 1, so as to reduce difficulty in forming the positive avoidance port and the negative avoidance port, and to facilitate mounting and connection of another structure. The positive lead 41 of the heating film 4 extends through the positive avoidance port 71 and is electrically connected with the distribution box 2. The negative lead 42 of the heating film 4 extends through the negative avoidance port 72 and is electrically connected with the distribution box 2. That is to say, the electrode lead of the heating film 4 directly passes through the lead avoidance port and is electrically connected with the distribution box 2, which reduces a length of connection between the electrode lead and the distribution box, reduces an entire volume of the battery pack 100, and facilitates formation of a heating circuit between the heating film 4 and the distribution box 2, that is, the distribution box 2 can supply power to the heating film 4. In this way, during heating of the cell, power is supplied to the heating film 4 through the distribution box 2, so that the heating film 4 is heated up, and then the heat is transmitted to the cell through the battery box 1, to heat up the cell.

In some embodiments, the battery pack 100 further includes a sealing plate 10. The sealing plate 10 is mounted above the battery box 1, and the heating film 4 is located between the sealing plate 10 and the battery box 1. It may be understood that, as shown in FIG. 4 and FIG. 5, the heating film 4 is arranged/disposed between the sealing plate 10 and the battery box 1. The sealing plate 10 may be configured as a plate-shaped structure, to facilitate mounting of the sealing plate 10 above the battery box 1, thereby sealing the positive avoidance port 71 and the negative avoidance port 72 through the sealing plate 10, and protecting the heating film 4.

Further, the heating film 4 is located between the sealing plate 10 and the battery box 1. In other words, the heating film 4 is arranged/disposed between the sealing plate 10 and the battery box 1. The sealing plate 10 protects the heating film 4, and is configured to be turned on at a low temperature to heat the battery pack 100. In this way, thermal uniformity of the battery pack 100 is realized, and the service life of the cell is increased.

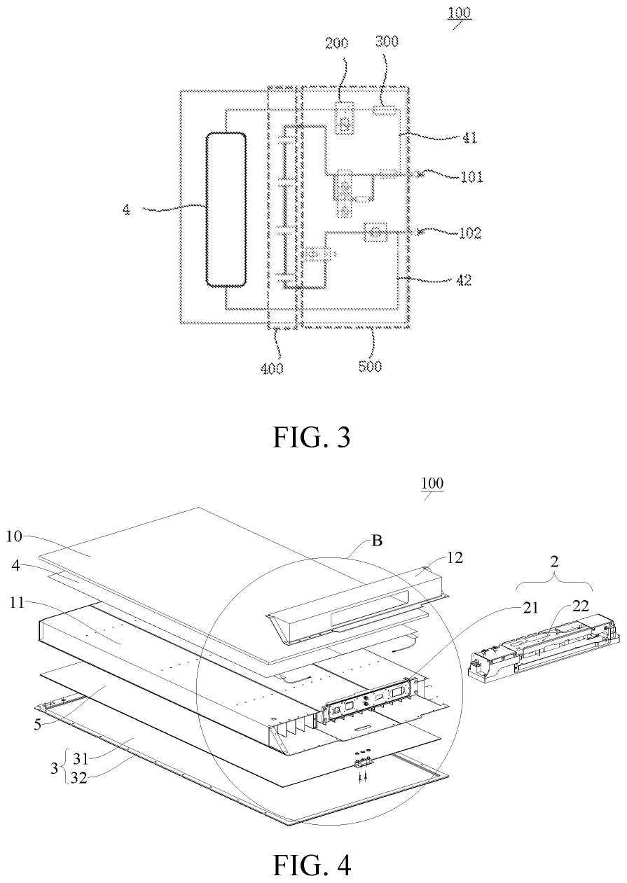

It should be noted that, as shown in FIG. 3, the heating film 4 is electrically connected with the distribution box 2, which forms a heating circuit for the battery pack 100. The positive lead 41 and the negative lead 42 of the heating film 4 pass through a cell area 400 and a distribution box area 500, and are connected with a battery pack positive lead 101 and a battery pack negative lead 102, respectively. In addition, a relay 200 and a fuse 300 are further connected to a line of the positive lead 41 of the heating film 4, to adjust and control the heating circuit, so as to enhance safety of the heating circuit. Moreover, when the heating film 4 is electrically connected with the distribution box 2, the heating film may be turn on in a case that the battery pack 100 is at a low temperature, to heat the cell. In this way, the thermal uniformity of the battery pack 100 is realized, which increases the service life of the cell, and enhances the practicality and safety of the battery pack 100.

In some embodiments, as shown in FIG. 4, the bottom protection plate 3 includes a groove area 31 recessed downward and a connection turnup 32 surrounding the groove area 31. The thermoregulation member 5 is mounted in the groove area 31. The groove area 31 and the connection turnup 32 may be integrally formed to reduce the processing difficulty.

In an embodiment, the groove area 31 is recessed away from the battery box 1, to form an avoidance space. The thermoregulation member 5 is located in the groove area 31, that is, during the mounting, the thermoregulation member 5 is mounted between the battery box 1 and the bottom protection plate 3, and the thermoregulation member 5 is located between the groove area 31 and the battery box 1. Therefore, since the groove area 31 avoids the thermoregulation member 5, quick mounting of the thermoregulation member 5 can be realized, and since the groove area 31 limits the thermoregulation member 5, random movement of the thermoregulation member is prevented.

The connection turnup 32 is configured to be detachably connected with the battery box 1, which facilitates detachable mounting of the bottom protection plate 3 to a lower side of the battery box 1, reduces mounting difficulty, and facilitates detachment of the bottom protection plate 3, thereby reducing maintenance costs of the battery pack 100, and enhancing the practicality of the battery pack 100.

In some embodiments, as shown in FIG. 2, the battery box 1 further includes a cell mounting cavity 111.

The cell mounting cavity 111 is formed in an internal space of the box portion 11. The cell mounting cavity 111 is configured to mount a cell, and the cell is electrically connected with the distribution box 2. Multiple cell mounting cavities 111 may be configured, so that multiple cells may be separately mounted in the cell mounting cavities 111, thereby facilitating assembly of the cells, and realizing support and protection of the cells through the cell mounting cavities 111.

As shown in FIG. 1, the distribution cavity 13 is located at an end portion of the cell mounting cavity 111, and the cell is electrically connected with the distribution box 2, to reduce a length of connection between the cell and the distribution box 2, thereby improving a volume integration of the battery pack 100, reducing the entire volume of the battery pack 100, and facilitating the electrical connection between the cell and the distribution box 2, and thus enhancing the practicality of the battery pack 100.

As shown in FIG. 1 and FIG. 2, in some embodiments, the battery box 1 includes the box portion 11 and the sealing cover 12.

The heating film 4 is connected with the box portion 11, which is configured to be turned on at a low temperature to heat the battery pack 100, so as to achieve thermal uniformity of the battery pack 100, thereby improving the service life of the cell. In addition, the heating film 4 is mounted to the outer side of the battery box 1 and is connected through the thermally conductive structural adhesive, so that surroundings of the cell can have a uniform temperature during heating or cooling through high thermal conductivity of the aluminum alloy battery box, thereby reducing the life degradation of lithium batteries caused by non-uniform temperatures.

The sealing cover 12 may be configured as a structure with an opening. The sealing cover 12 is mounted to an end portion of the box portion 11 and defines the distribution cavity 13 with the box portion 11, so as to fixedly mount the distribution box 2 in the distribution cavity 13, thereby preventing the displacement or detachment of the distribution box 2, and enhancing the stability of the distribution box 2. Moreover, the opening of the sealing cover 12 is recessed away from an upper surface of the box portion 11, so as to mount the sealing cover 12 on an upper side of the box portion 11. Further, the sealing cover 12 and the box portion 11 jointly define the distribution cavity 13 for mounting the distribution box 2. The sealing cover 12 is provided with the mounting port 121. The mounting port 121 is arranged/disposed on a side wall of the sealing cover 12. The mounting port 121 may be configured as an elongated hole. The mounting port 121 is configured to avoid to the panel 22, to facilitate the user operations, thereby improving the convenience of the user operations. It may be understood that during the mounting, the distribution box 2 may be first mounted to an upper surface of the box portion 11, then the sealing cover 12 is mounted to the distribution box 2, and the panel 22 protrudes out through the mounting port 121. In this way, the sealing cover 12 can protect the distribution box 2, which prevents the distribution box 2 from the direct impact, and facilitates the user operations on the distribution box 2 through the panel 22 at the mounting port 121, thereby enhancing the safety and practicality of the distribution box 2.

It should be noted that, the sealing cover 12 and the upper surface of the box portion 11 are sealed by using the bolt and the compressible material through mechanical compression. A level of the sealing may be IP67, which enhances the sealing and safety of the battery pack 100.

A vehicle in the embodiments of the present disclosure is briefly described below.

As shown in FIG. 6, a vehicle 600 in the embodiments of the present disclosure includes the above battery pack 100. Since the vehicle 600 in the embodiments of the present disclosure is provided with the above battery pack 100, a battery storage unit of the vehicle 600 has a simple structure and requires low costs, thereby reducing manufacturing costs of the whole vehicle.

In the descriptions of the present disclosure, it should be understood that orientation or position relationships indicated by the terms such as “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “anticlockwise”, “axial direction”, “radial direction”, and “circumferential direction” are based on orientation or position relationships shown in the drawings, and are merely used for ease and brevity of description of the present disclosure, rather than indicating or implying that the mentioned device or element needs to have a particular orientation or be configured and operated in a particular orientation. Therefore, such terms should not be construed as a limitation on the present disclosure.

In addition, the terms “first” and “second” are merely used for the purpose of description, and shall not be construed as indicating or implying relative importance or implying a quantity of indicated technical features. Therefore, features defined by “first” and “second” may explicitly or implicitly include one or more such features. In the descriptions of the present disclosure, “multiple” means more than two, unless otherwise defined.

In the present disclosure, unless otherwise explicitly specified or defined, the terms such as “mount”, “connect”, “connection”, and “fix” should be understood in a broad sense. For example, the connection may be a fixed connection, a detachable connection, or an integral connection; or the connection may be a mechanical connection or an electrical connection; or the connection may be a direct connection, an indirect connection through an intermediate medium, internal communication between two elements, or an interaction relationship between two elements. A person of ordinary skill in the art may understand the meanings of the above terms in the present disclosure according to the situations.

In the present disclosure, unless otherwise explicitly specified and defined, a first feature being “on” or “under” a second feature may indicate that the first feature is in direct contact with the second feature, or the first feature is in indirect contact with the second feature by using an intermediate medium. In addition, the first feature being “above”, “over”, or “on” the second feature may indicate that the first feature is directly above or obliquely above the second feature, or may merely indicate that the first feature is at a higher horizontal position than the second feature. The first feature being “below”, “under”, and “beneath” the second feature may indicate that the first feature is directly below or obliquely below the second feature, or merely indicates that the first feature is at a lower horizontal position than the second feature.

In the descriptions of the specification, a description with reference to terms such as “an embodiment”, “some embodiments”, “an example”, “a specific example”, or “some examples” means that specific features, structures, materials, or characteristics described with reference to the embodiment or the example is included in at least one embodiment or example of the present disclosure. In this specification, exemplary descriptions of the above terms are not necessarily directed at the same embodiment or example. Besides, the features, the structures, the materials, or the characteristics that are described may be combined in proper manners in any one or more embodiments or examples. In addition, a person skilled in the art may integrate or combine different embodiments or examples described in the specification and features of the different embodiments or examples as long as they are not contradictory to each other.

Although the embodiments of the present disclosure have been shown and described above, it may be understood that, the above embodiments are exemplary and should not be understood as a limitation on the present disclosure. A person of ordinary skill in the art may make changes, modifications, replacements, or variations to the above embodiments within the scope of the present disclosure.

What is claimed is:

1. A battery pack, comprising:
a battery box having a distribution cavity; a distribution box disposed in the distribution cavity; the distribution box comprising a panel; the panel having a first flow channel and a refrigerant inlet/outlet joint in communication with the first flow channel; and
a thermoregulation member connected with the battery box; the thermoregulation member having a second flow channel in communication with the first flow channel.

2. The battery pack according to claim 1, wherein the thermoregulation member is disposed below the battery box; a liquid cooling avoidance port is disposed on a bottom wall of the distribution cavity; and an adapter of the second flow channel extends through the liquid cooling avoidance port and is in communication with the first flow channel.

3. The battery pack according to claim 2, wherein the adapter comprises an adapter inlet and an adapter outlet; and the adapter inlet and the adapter outlet extend into the distribution cavity through the liquid cooling avoidance port.

4. The battery pack according to claim 3, wherein the refrigerant inlet/outlet joint comprises an outer inlet and an outer outlet disposed on an outer side surface of the panel,
wherein the outer inlet is in communication with the adapter inlet; the outer outlet is in communication with the adapter outlet; and the outer inlet and the outer outlet are configured to be in communication with an external pipeline.

5. The battery pack according to claim 4, wherein a mounting port in communication with an outside of the battery box is disposed in the distribution cavity; the panel is disposed facing the mounting port; and the outer inlet and the outer outlet extend through the mounting port.

6. The battery pack according to claim 5, wherein the battery box comprises a box portion and a sealing cover; the thermoregulation member is connected with the box portion; the sealing cover is mounted to an end portion of the box portion; the sealing cover and the box portion define the distribution cavity; and the sealing cover comprises the mounting port.

7. The battery pack according to claim 2, further comprising a bottom protection plate covering a bottom of the battery box; wherein the thermoregulation member is located between the battery box and the bottom protection plate.

8. The battery pack according to claim 2, further comprising a heating film mounted above or below the battery box; wherein the heating film is electrically connected with the distribution box.

9. The battery pack according to claim 8, wherein the heating film is disposed between the battery box and the thermoregulation member; a lead avoidance port is disposed on the bottom wall of the distribution cavity; the lead avoidance port is spaced apart from the liquid cooling avoidance port; and an electrode lead of the heating film extends through the lead avoidance port and is electrically connected with the distribution box.

10. The battery pack according to claim 9, wherein the heating film is disposed above the battery box; a top wall of the battery box comprises the lead avoidance port; and an electrode lead of the heating film extends through the lead avoidance port and is electrically connected with the distribution box.

11. The battery pack according to claim 10, further comprising a sealing plate mounted above the battery box; wherein the heating film is located between the sealing plate and the battery box.

12. The battery pack according to claim 7, wherein the bottom protection plate comprises a groove area recessed downward and a connection turnup surrounding the groove area; the connection turnup is configured to be detachably connected with the battery box; and the thermoregulation member is mounted in the groove area.

13. The battery pack according to claim 1, further comprising a cell mounting cavity configured to mount a cell; wherein the distribution cavity is located at an end portion of the cell mounting cavity, and the cell is electrically connected with the distribution box.

14. A vehicle, comprising a battery pack comprising:
a battery box having a distribution cavity; a distribution box disposed in the distribution cavity; the distribution box comprising a panel; the panel having a first flow channel and a refrigerant inlet/outlet joint in communication with the first flow channel; and
a thermoregulation member connected with the battery box; the thermoregulation member having a second flow channel in communication with the first flow channel.

15. The vehicle according to claim 14, wherein the thermoregulation member is disposed below the battery box; a liquid cooling avoidance port is disposed on a bottom wall of the distribution cavity; and an adapter of the second flow channel extends through the liquid cooling avoidance port and is in communication with the first flow channel.

16. The vehicle according to claim 15, wherein the adapter comprises an adapter inlet and an adapter outlet; and the adapter inlet and the adapter outlet extend into the distribution cavity through the liquid cooling avoidance port.

17. The vehicle according to claim 16, wherein the refrigerant inlet/outlet joint comprises an outer inlet and an outer outlet disposed on an outer side surface of the panel,
wherein the outer inlet is in communication with the adapter inlet; the outer outlet is in communication with the adapter outlet; and the outer inlet and the outer outlet are configured to be in communication with an external pipeline.

18. The vehicle according to claim 17, wherein a mounting port in communication with an outside of the battery box is disposed in the distribution cavity; the panel is disposed facing the mounting port; and the outer inlet and the outer outlet extend through the mounting port.

19. The vehicle according to claim 18, wherein the battery box comprises a box portion and a sealing cover; the thermoregulation member is connected with the box portion; the sealing cover is mounted to an end portion of the box portion; the sealing cover and the box portion define the distribution cavity; and the sealing cover comprises the mounting port.

20. The vehicle according to claim 15, wherein the battery pack further comprises a bottom protection plate covering a bottom of the battery box; and the thermoregulation member is located between the battery box and the bottom protection plate.
